(19) United States
(12) Patent Application Publication
(10) Pub. No.: US 2026/0239515 A1
(43) Pub. Date: Aug. 13, 2026

(54) DMX ADDRESS CONFIGURATION FOR LUMINAIRE

(71) Applicant: Aputure Imaging Industries Co., Ltd., Shenzhen (CN)

(72) Inventor: Peng XIE, Shenzhen (CN)

(21) Appl. No.: 19/463,637

(22) Filed: Jan. 29, 2026

(30) Foreign Application Priority Data
Feb. 13, 2025 (CN) 202510160817.3

(51) Int. Cl. H05B 47/18; H05B 47/125

(52) U.S. Cl. CPC H05B 47/184; H05B 47/125

(57) ABSTRACT

The application provides a DMX address configuration method, system, program, device for luminaire, and a luminaire. The method applies to a control terminal including a first NFC module. The method includes: acquiring luminaire position information of one or more luminaires in a shooting scene, wherein each of the one or more luminaires comprises a second NFC module and a control module communicatively connected with the second NFC module; generating a DMX address of each of the one or more luminaires based on the luminaire position information; and writing, by the first NFC module, the DMX address of each of the one or more luminaires into the second NFC module of a corresponding one of the one or more luminaires, so that upon being powered on, the control module of each of the one or more luminaires reads the DMX address received by the second NFC module of the luminaire.

### CROSS-REFERENCE TO RELATED APPLICATION

This application claims priority to and the benefit of Chinese Patent Application No. 202510160817.3, filed on February 13, 2025, the disclosure of which is incorporated herein by reference in its entirety.

### TECHNICAL FIELD

The present application relates to the field of lighting control, and in particular, to a Digital Multiplex (DMX) address configuration method, system, program, device for luminaire, and a luminaire.

### BACKGROUND

In order to precisely control each lighting device on set, it's necessary to determine the DMX address of each luminaire and use a luminaire control device to control the lighting. Currently, DMX addresses must be manually configured, which is not only inefficient but also requires a high level of operator experience.

Therefore, how to configure the control address of the luminaires to improve configuration efficiency has become a technical problem that needs to be solved urgently in the industry.

### SUMMARY

Embodiments of the present application provide a DMX address configuration method, system, program, device for luminaire, and a luminaire, which improves configuration efficiency and at least partially solves the above technical problems.

In a first aspect, an embodiment of the present application provides a DMX address configuration method for luminaire, which is applied to a control terminal including a first Near Field Communication (NFC) module, and the method including:

acquiring luminaire position information of one or more luminaires in a shooting scene, wherein each of the one or more luminaires includes a second NFC module and a control module communicatively connected with the second NFC module;

generating a DMX address of each of the one or more luminaires based on the luminaire position information; and

writing, by the first NFC module, the DMX address of each of the one or more luminaires into the second NFC module of a corresponding one of the one or more luminaires, so that upon being powered on, the control module of each of the one or more luminaires reads the DMX address received by the second NFC module of the luminaire.

In a second aspect, an embodiment of the present application provides a DMX address configuration method for luminaire, applied to a luminaire including a second NFC module and a control module, and the method including:

receiving, by the second NFC module, a DMX address of the luminaire in the shooting scene transmitted from the control terminal; and

upon being powered on, reading the DMX address, and performing DMX address configuration on the luminaire based on the DMX address;

wherein the DMX address is generated based on position information of the luminaire in the shooting scene.

In a third aspect, the present application provides a luminaire control system, including:

a control terminal, configured to perform the above DMX address configuration method for luminaire applied to a control terminal; and/or

a luminaire, configured to perform the above DMX address configuration method for luminaire applied to a luminaire.

In a fourth aspect, an embodiment of the present application provides an application program, which, when executed by a processor, causes the processor to implement the DMX address configuration method for luminaire applied to a luminaire.

In a fifth aspect, an embodiment of the present application provides an electronic device, including:

a memory, having stored thereon a computer program; and

processor,

wherein the computer program, when executed by the processor, causes the processor to implement the above DMX address configuration method.

In a sixth aspect, an embodiment of the present application provides a luminaire, including:

a memory, having stored thereon a computer program; and

a control module;

wherein the computer program, when executed by the control module, causes the control module to execute the above DMX address configuration method for luminaire.

### BRIEF DESCRIPTION OF THE DRAWINGS

In order to more clearly illustrate the technical solutions in the embodiments of the present application, the following briefly introduces the drawings required for use in the description of the embodiments. Obviously, the drawings described below are only some embodiments of the present application. For those skilled in the art, other drawings can be obtained based on these drawings without creative work.

FIG. 1 is a flow chart of a DMX address configuration method for luminaire according to an embodiment of the present application.

FIG. 2 is a schematic diagram of the structure of an address configuration system according to an embodiment of the present application.

FIG. 3 is a second flow chart of a DMX address configuration method for luminaire according to an embodiment of the present application.

FIG. 4 is a schematic diagram of the structure of an address configuration device according to an embodiment of the present application.

FIG. 5 is a schematic structural diagram of an electronic device according to an embodiment of the present application.

FIG. 6 is a schematic structural diagram of a luminaire according to an embodiment of the present application.

### DETAILED DESCRIPTION OF THE EMBODIMENTS

To make the objectives, technical solutions, and advantages of this application more clear, the technical solutions in this application will be clearly and completely described below in conjunction with the accompanying drawings in the embodiments of this application. Obviously, the described embodiments are only part of the embodiments of this application, not all of them. Based on the embodiments in this application, all other embodiments obtained by ordinary technicians in this field without making any creative efforts are within the scope of protection of this application.

It should be noted that the terms "first", "second" etc. in this application are used to distinguish similar objects, and are not necessarily used to describe a specific order or sequential order. It should be understood that the data used in this way can be interchangeable in appropriate circumstances, so that the embodiments of the application described herein can be implemented in an order other than those illustrated or described herein. In addition, the terms "including" and "having" and any of their variations are intended to cover non-exclusive inclusions, for example, the process, method, system, product or equipment comprising a series of operations or modules is not necessarily limited to those operations or modules clearly listed, but may include other operations or modules that are not clearly listed or that are inherent to these processes, methods, products or equipment.

The DMX address configuration method for luminaire provided in the embodiments of the present application is applicable to a control terminal, which can be various electronic devices with a display screen and supporting web browsing, including but not limited to servers, smart phones, tablet computers, laptops, and desktop computers.

FIG. 1 is a flow chart of a DMX address configuration method for luminaire according to an embodiment of the present application. As shown in FIG. 1, the method includes operations 110, 120, and 130. The operations of the method flow are merely a possible implementation of the present application.

Operation 110: Acquiring luminaire position information of one or more luminaires in a shooting scene, where the luminaire includes a second NFC module and a control module communicatively connected with the second NFC module.

Specifically, the DMX address configuration method for luminaire provided in the embodiments of the present application is implemented by a DMX address configuration device for the luminaire. This device can be a hardware device independently provided in a control terminal, or a software program running in the control terminal. For example, in the condition that the control terminal is a mobile phone, the DMX address configuration device for the luminaire can be implemented as an application such as address configuration software in the mobile phone.

The shooting scene refers to a scene that needs to be shot on set, such as a palace scene or an office scene, etc. The shooting scene includes at least one lighting luminaire.

The luminaire position information may include the number of luminaires and the relative position relations of luminaires.

The control module of the luminaire is configured to manage and adjust lighting effects. It can execute control signals to control the luminaire's lighting effects. The second NFC module and the control module can be integrated into the luminaire control device of the luminaire. The luminaire control device can be a luminaire control box.

In the shooting scene, one luminaire corresponds to one luminaire control device, multiple luminaires correspond to one luminaire control device, or all luminaires correspond to one luminaire control device. The number of luminaire control devices can be set according to actual conditions.

Operation 120: Generating a DMX address for each of the one or more luminaires based on the luminaire position information.

The DMX address is an address used to identify and control a specific lighting device or function of a device. A DMX address is a Digital Multiplex Signal (DMX) address, which can be a specific number within a digital multiplex channel. The DMX address allows a control terminal to locate and control the luminaire corresponding to the DMX address.

The control terminal is configured to obtain the luminaire position information of the one or more luminaires in the shooting scene, and generate a DMX address for each luminaire according to the luminaire position information.

The number of DMX addresses that need to be assigned can be known based on the luminaire position information. Therefore, a DMX address can be assigned to each luminaire in the shooting scene according to the luminaire position information for the shooting scene. The control terminal can accurately control the lighting effects of each luminaire through the DMX address, such as controlling the brightness, color and strobe of the light.

Operation 130: Writing, by the first NFC module, the DMX addresses of the one or more luminaires into the second NFC modules of each of the one or more luminaires, so that upon being powered on, the control module of each luminaire reads the DMX address received by the second NFC module of the luminaire.

Specifically, if one luminaire in the shooting scene corresponds to one luminaire control device, the DMX address assigned to any luminaire in the shooting scene is sent, by the first NFC module, to the second NFC module of the luminaire control device corresponding to the luminaire, and the DMX address of the luminaire is configured as the assigned DMX address by the control module of the luminaire control device.

If multiple luminaires or all luminaires in the shooting scene correspond to one luminaire control device, the DMX addresses assigned to the multiple luminaires or all luminaires are sent to the second NFC module in the luminaire control device by the first NFC module, and the DMX addresses of the multiple luminaires or all luminaires are configured as the assigned DMX addresses by the control module of the luminaire control device.

The control terminal can be brought close to the second NFC module of the luminaire control device of the luminaire. The DMX address assigned by the control terminal to the luminaire will be directly written into the second NFC module. After the control module of the luminaire control device is powered on, the control module of the luminaire control device will first read the DMX address in the second NFC module and then automatically configure the read DMX address.

The DMX address configuration method for luminaire provided in the embodiments of the present application can automatically assign a DMX address to each luminaire in the shooting scene based on the luminaire position information by obtaining the luminaire position information of one or more luminaires in the shooting scene, without manual assignment, thereby improving the efficiency of DMX address assignment; the DMX address is sent to the second NFC module of the luminaire in the shooting scene by the first NFC module of the control terminal, and the DMX address received by the second NFC module of the luminaire can be read after the control module of the luminaire is powered on to configure the DMX address of the luminaire, reducing manual participation and improving the efficiency of DMX address configuration; in addition, in the related art, each luminaire in the shooting scene needs to be set up and powered on before the DMX address of each luminaire can be manually configured, while the DMX address configuration method for luminaire provided in the embodiment of the present application only needs to obtain the luminaire position information for the shooting scene to assign a DMX address to each luminaire in the shooting scene, that is, the DMX address configuration method for luminaire provided in the embodiments of the present application can generate the DMX address of each luminaire before the luminaire is set up or powered on, thereby improving the efficiency of DMX address configuration.

It should be noted that each implementation of the present application can be freely combined, the order can be changed, or it can be executed separately, and does not need to rely on or depend on a fixed execution order.

In some embodiments, operation 110 includes:

acquiring one or both of a scene image or scene video of the shooting scene; and

identifying the one or both of the scene image or scene video.

Specifically, the one or both of the scene image or the scene video of the shooting scene refers to an image and/or video including the one or more luminaires in the shooting scene.

The scene image and/or video of the shooting scene can be preprocessed and analyzed using computer vision techniques to extract characteristic information about the one or more luminaires. These characteristics can include the shape, color, texture, etc. For example, different types of luminaires may have unique outlines or color patterns. By extracting and analyzing these characteristics, luminaires can be distinguished from other objects.

The target detection algorithm can be used to locate and identify the luminaires in the scene, accurately detect the position of the luminaires in the scene image and/or video, and thus obtain the luminaire position information.

In some embodiments, operation 110 includes:

inputting an environmental image of the shooting scene into an address configuration model; and

in a condition that the environmental image includes the one or more luminaires, acquiring the DMX address generated by the address configuration model based on the luminaire position information in the environmental image; in a condition that the environmental image does not include the one or more luminaires, acquiring the luminaire position information output by the address configuration model and the DMX address generated based on the luminaire position information.

Specifically, the environment image refers to an image of a shooting environment including a shooting scene, and the environment image may or may not contain a luminaire.

The address configuration model can be a neural network model, which can be constructed by a convolutional neural network model, a fully connected neural network model, a recurrent neural network model, and/or a long short-term memory neural network model.

A training sample can be constructed using an environmental image sample, the luminaire position information corresponding to the environmental image sample, and the DMX address sample of the luminaire corresponding to the environmental image sample. An initial address configuration model is trained using the training sample to obtain a final address configuration model.

For example, a training sample and an initial address configuration model are acquired, where the training sample includes an environmental image sample, luminaire position information corresponding to the environmental image sample, and a DMX address sample of the luminaire corresponding to the environmental image sample; the environmental image sample, the luminaire position information corresponding to the environmental image sample, and the DMX address sample of the luminaire corresponding to the environmental image sample are input into the initial address configuration model, and the initial feature extraction network of the initial address configuration model extracts sample features of the environmental image sample. If the environmental image sample includes a luminaire, features of the luminaire position information can also be extracted. These features are fused and input into the decision maker of the initial address configuration model to acquire the DMX address output by the initial address configuration model, or the generated luminaire position information and the DMX address predicted by the initial address configuration model are obtained, and the predicted luminaire position information and the generated DMX address are compared with the luminaire position information corresponding to the environmental image sample and the DMX address sample of the luminaire corresponding to the environmental image sample to obtain loss data, and the model parameters of the initial address configuration model are adjusted according to the loss data, and the initial address configuration model is further trained according to the data set to be trained until the initial address configuration model can accurately predict the luminaire position information and generate the DMX address.

An environment image showing luminaires is input into the address configuration model, and the address configuration model can output the luminaire position information corresponding to the environment image, and generate the DMX address of each luminaire based on the luminaire position information. An environment image showing luminaires is input into the address configuration model, and the address configuration model can identify the luminaire position information based on the environment image, and generate the DMX address of each luminaire based on the luminaire position information.

Therefore, the address configuration model can not only generate DMX addresses for luminaires, but also provide luminaire position information for the shooting scene based on the environmental image when the luminaire position information is not determined. The luminaire position information here can include information such as luminaire type, luminaire quantity and luminaire placement.

The DMX address configuration method for luminaire provided in the embodiments of the present application obtains luminaire position information by identifying scene images and/or scene videos of the shooting scene, and then generates the DMX address of the luminaire based on the luminaire position information, thereby improving the efficiency of DMX address generation.

In some embodiments, the identifying of the scene image to acquire the luminaire position information includes:

analyzing the scene image to identify each luminaire in the scene image;

acquiring relative position relations and quantity information of luminaires in the scene image; and

determining the luminaire position information based on the relative position relations and the quantity information.

Specifically, each luminaire in the scene image can be identified based on computer vision techniques (such as edge detection, feature matching, or network models). All identified luminaire objects are traversed and counted to obtain the quantity information of the luminaires in the shooting scene.

The specific position of each luminaire is determined in the scene image. For example, a coordinate system is constructed in the scene image, and the center point coordinates or bounding box coordinates of each luminaire are recorded to obtain the specific position of each luminaire in the scene image. The relative position relations of the luminaires are determined based on their positional relationships in the scene.

The luminaire position information is determined based on the relative position relations and the quantity information.

The DMX address configuration method for luminaire provided in the embodiments of the present application can obtain the luminaire position information of the shooting scene by analyzing the scene image, thereby improving the efficiency of obtaining the luminaire position information.

In some embodiments, operation 110 includes:

matching first scene information of the shooting scene with second scene information of a past shooting scene; and

using the luminaire position information of the one or more luminaires in the past shooting scene corresponding to the second scene information matching the first scene information as the luminaire position information of the one or more luminaires in the shooting scene.

Specifically, the first scene information refers to relevant information of the luminaires in the shooting scene, such as a picture, video and scene name of the shooting scene, etc. Both the picture and video of the shooting scene involve at least one luminaire.

The past shooting scene can be a scene that has already been shot or a custom scene.

The second scene information refers to relevant information of the past shooting scene, such as pictures, videos and scene names of the past shooting scene, etc. The pictures and videos of the past shooting scene both involve at least one luminaire.

By matching the first scene information of the shooting scene with the second scene information of the past shooting scene, a matching result can be obtained, where the matching result includes a matching success result and a matching failure result.

For example, the first scene information and the second scene information are both pictures, and the picture of the shooting scene is matched with scene pictures of various past shooting scenes stored in the control terminal to obtain a matching result.

The first scene information can be matched with the second scene information by using a neural network model.

For example, an initial neural network model is trained based on the first scene information sample and the matching result sample to obtain a neural network model. The first scene information is input into the neural network model to obtain a matching result output by the neural network model. The neural network model stores the second scene information of each past shooting scene.

When both the first scene information and the second scene information are pictures, they can also be matched using feature points in the picture of the shooting scene and the pictures of the past shooting scenes, and the matching method is not limited here.

The control terminal stores not only the second scene information of the past shooting scene but also the luminaire position information of the past shooting scene.

If the matching result is a matching success result, the luminaire position information corresponding to the second scene information can be obtained based on the matched second scene information, and the luminaire position information corresponding to the second scene information can be used as the luminaire position information for the shooting scene.

For example, the shooting scene is a palace scene, and there are palace scenes in the past shooting scenes. The first scene information includes the shooting scene name "Palace Scene". The first scene information is matched with the name in the second scene information of each past shooting scene stored in the control terminal, and the matching result is successful. The luminaire position information corresponding to the "Palace Scene" in the past shooting scene is used as the luminaire position information of the shooting scene.

If the matching result is a matching failure result, the first scene information can be identified to obtain the luminaire position information for the shooting scene. For example, the first scene information is an image of the shooting scene, and the image is identified based on image recognition technology to obtain the luminaire position information for the shooting scene.

The DMX address configuration method for luminaire provided in the embodiments of the present application matches the first scene information of a shooting scene with the second scene information of a past shooting scene. When the match is successful, the luminaire position information of the luminaires in the shooting scene can be quickly obtained, thereby improving the efficiency of obtaining luminaire position information. In some embodiments, the luminaire position information includes the quantity information of luminaires and the relative position relations of the luminaires; operation 120 includes:

determining the quantity of DMX addresses based on the quantity information of luminaires; and

generating the DMX address of each luminaire based on the quantity of DMX addresses and the relative position relations.

Specifically, the relative position relations can be used to determine the configuration order of the DMX addresses of the luminaires in the shooting scene; the DMX addresses are used to identify and control the corresponding luminaires.

A luminaire ID can be generated for each luminaire. Each luminaire corresponds to a unique luminaire ID and a unique DMX address. Therefore, the quantity of luminaires is the same as the quantity of luminaire IDs as well as the quantity of DMX addresses. For example, if there are 5 luminaires, 5 different luminaire IDs and 5 different DMX addresses need to be generated.

The luminaire IDs and the DMX addresses are associated and stored. The luminaire ID can be the luminaire number. For example, if there are five different luminaire IDs, namely 1, 2, 3, 4, and 5, each of them is associated with one DMX address and stored in the control terminal.

Since the luminaires in the shooting scene are placed according to their relative positions, the DMX addresses of the luminaires in the shooting scene are configured in sequence according to their relative position relations. This can facilitate the configuration of the DMX address of each luminaire and prevent the omission of a luminaire from being configured.

The DMX address configuration method for luminaire provided in the embodiments of the present application generates the DMX address of each luminaire based on the quantity the DMX address and the relative position relations of the luminaires, and can assign a corresponding DMX address to each luminaire, thereby achieving precise control of each luminaire.

In an embodiment, after obtaining the unique luminaire ID and unique DMX address, as well as the relative position relations, of each luminaire, the luminaire position information in the shooting scene is mapped and displayed on a user interface of a control terminal based on the relative position relations and the 3D/2D model of the luminaire. The 3D/2D model of each luminaire is displayed on the user interface according to the relative position relations, and the unique luminaire ID and/or unique DMX address configured for each luminaire is also displayed on the user interface. The model, luminaire ID, and DMX address of each luminaire are displayed in a first format, a second format, and a third format, respectively. The first format may be a 3D/2D model format, and the second and third formats may be digital formats.

After the luminaire control device configures the DMX address of a luminaire, it can send the configuration result to the control terminal. The control terminal can then adjust the display effect of the luminaire on the user interface based on the configuration result. The configuration result includes a configuration success result and configuration failure result. For example, a luminaire that has not yet been configured with a DMX address or has a configuration failure result will be displayed in gray on the user interface; a luminaire that has been configured with a DMX address, that is, a luminaire with a configuration success result, will be displayed in color on the user interface. The display effect of the luminaire can be used to determine whether the DMX address of the lighting luminaire has been configured.

Text describing the configuration status of a luminaire can be displayed near the displayed luminaire on the user interface. For example, a luminaire that has not yet been configured with a DMX address will display the text "Not configured" near it on the user interface; a luminaire that has been configured with a DMX address will display the text "Configured" near it on the user interface. The text displayed near the luminaire can be used to determine whether the DMX address of the luminaire has been configured.

In some embodiments, operation 130 includes:

detecting whether the first NFC module is connected to a second NFC module of any luminaire in the shooting scene;

in a condition that the first NFC module is connected to the second NFC module of any luminaire in the shooting scene, the DMX address associated with the luminaire is sent to the second NFC module of the luminaire.

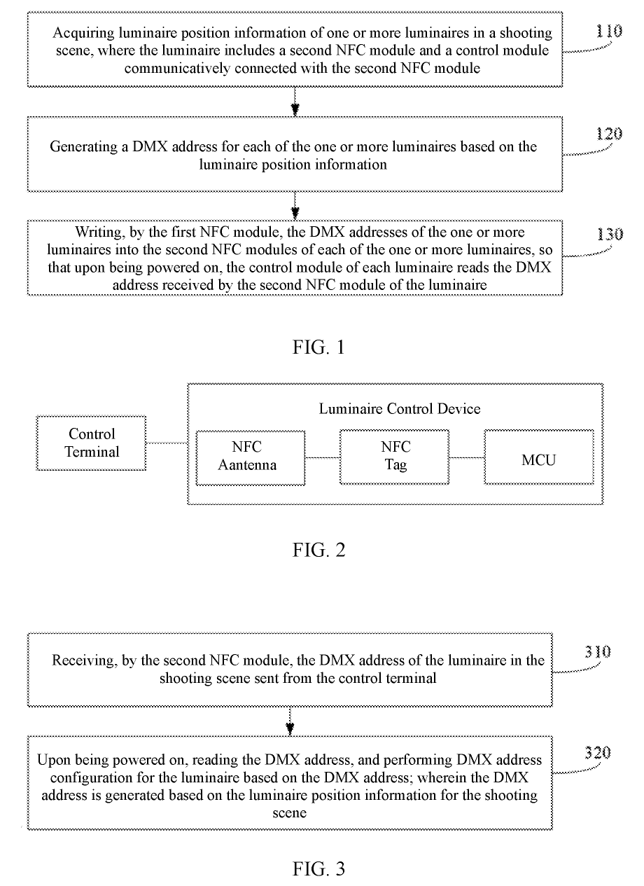

Specifically, FIG. 2 is a schematic diagram of the structure of an address configuration system according to an embodiment of the present application. As shown in FIG. 2, the address configuration system mainly includes a control terminal with a near field communication (NFC) function. The control terminal can be installed with an application that can configure DMX addresses and other related information. The control terminal can read the information of the NFC tag of the luminaire control device and can also write information to the NFC tag of the luminaire control device. The luminaire control device includes a micro control unit (MCU), that is, a control module, an NFC tag and an NFC antenna. The micro control unit communicates with the NFC tag through communication protocols such as SPI or IIC. The second NFC module includes the NFC tag and the NFC antenna. The NFC tag can be a chip such as NTA5332, NT3H2111 or NTP5210, etc., and the chip with appropriate capacity can be selected according to actual needs.

The control terminal can be configured with an application that is adapted to the NFC tag. As long as the first scene information of the shooting scene is uploaded to the application, the application will automatically assign the DMX address required for each luminaire in the shooting scene. The control terminal can then be placed close to the NFC tag or antenna of the luminaire control device. The DMX address assigned in the application will be directly written into the NFC tag. After the control module of the luminaire control device is powered on, it will first read the DMX address in the NFC tag, and then automatically configure the read DMX address.

For example, the control terminal is a mobile phone, and each luminaire has a luminaire control device. When the luminaire control device leaves the factory, it is powered on first, and information such as the luminaire control device's serial number, model, and date of manufacture is pre-written into the NFC tag in the luminaire control device. Whether the luminaire control device is powered on or off, the user can determine a shooting scene based on the shooting scene, place each luminaire in a suitable position based on the shooting scene, and then shoot the scene to obtain first scene information. This first scene information is uploaded to the mobile phone application. The application automatically generates the DMX address for each luminaire in the shooting scene based on the uploaded first scene information. The mobile phone approaches the NFC tag of the luminaire control device of each luminaire based on the relative position relations of the luminaire. When a connection is established between the mobile phone and the luminaire control device, that is, a connection is established between the first NFC module and the second NFC module of the luminaire, the mobile phone first obtains relevant information such as the factory version of the luminaire control device. After verifying that the information is correct, the corresponding DMX address and other relevant information are written. After the luminaire control device is powered on, the microcontroller unit will first read the information in the NFC tag to check whether the configuration-related content such as the DMX address has been updated. If so, it will obtain the information in the NFC tag and automatically update it to the control program of the luminaire control device.

The DMX address configuration method for luminaire provided in the embodiments of the present application can store the DMX address and other related information that needs to be configured in advance into the NFC tag in the luminaire control device through the NFC function of the control terminal, regardless of whether the luminaire control device is powered on. This can reduce the time taken by the lighting engineer to complete the lighting of the entire scene and speed up the construction of the on-site lighting scene. In addition, the relevant information of the luminaire is directly configured through NFC function, the accuracy of the DMX address configuration is higher.

In some embodiments, before the luminaire control device leaves the factory, the version information, model, and production date of the luminaire control device will be written into the NFC tag of the luminaire control device in advance. When a connection is established between the control terminal and the luminaire control device, the control terminal will obtain the device information of the luminaire control device, and verify the luminaire control device based on the device information. After the verification is successful, the corresponding DMX address and other related information will be written.

The control terminal can also manage the luminaire control device based on the acquired device information, for example, determining whether the current version of the luminaire control device is the latest version and updating it if not. The device information can also include device maintenance records.

The DMX address configuration method for luminaire provided in the embodiments of the present application can directly obtain the device information of the luminaire control device through the control terminal so as to manage the luminaire control device.

In some embodiments, the DMX address configuration method for luminaire provided in the embodiments of the present application further includes:

turning on the first NFC module;

in a condition that the first NFC module is connected to the second NFC module, generating a Bluetooth connection signal;

sending the Bluetooth connection signal to a control module connected to the second NFC module, so that the control module activates a Bluetooth connection function based on the Bluetooth connection signal; and

identifying the control module and establishing a Bluetooth connection with the control module to transmit data through the Bluetooth connection.

Specifically, when the control module of the luminaire control device is powered on and the control terminal is connected to the control module, the Bluetooth module of the control module can be turned on to implement the automatic connection function of the Bluetooth application of the control terminal.

When the control terminal is connected to the control module, the control terminal can send a Bluetooth connection signal to the control module. Upon receiving the Bluetooth connection signal, the control module activates the Bluetooth connection function and generates a Bluetooth signal. The application in the control terminal automatically pairs and connects the control module after detecting the Bluetooth signal from the control module.

The DMX address configuration method for luminaire provided in the embodiments of the present application can increase the communication distance between the control terminal and the control module of the luminaire by turning on the Bluetooth of the control module through the control terminal and realizing the Bluetooth connection between the control terminal and the control module.

The execution subject of the DMX address configuration method for the lamp described above is the control terminal. The DMX address configuration method for luminaire whose execution subject is the luminaire in the shooting scene provided in the embodiments of the present application is described below. The DMX address configuration method for luminaire whose execution subject is the luminaire described below and the DMX address configuration method for luminaire whose execution subject is the control terminal can be referenced to each other.

FIG. 3 is a second flow chart of a DMX address configuration method for luminaire according to an embodiment of the present application. As shown in FIG. 3, the method is applied to a luminaire including a second NFC module and a control module. The method includes operations 310 and 320. The operations of the method flow are merely one possible implementation of the present application.

Operation 310: Receiving, by the second NFC module, the DMX address of the luminaire in the shooting scene sent from the control terminal;

Operation 320: Upon being powered on, reading the DMX address, and performing DMX address configuration for the luminaire based on the DMX address; wherein the DMX address is generated based on the luminaire position information for the shooting scene.

Specifically, the control terminal sends the generated DMX address to the luminaire control device of the luminaire. The luminaire control device receives the DMX address. If the control module of the luminaire control device is currently online, DMX address configuration will be performed for the connected luminaire directly according to the DMX address; if the control module of the luminaire control device is currently offline, the DMX address will be stored first, and after power-on, the DMX address will be read, and DMX address configuration will be performed for the connected luminaire based on the DMX address.

The DMX address configuration method for luminaire provided in the embodiments of the present application can automatically assign DMX addresses to each luminaire in the shooting scene based on the luminaire position information by obtaining the luminaire position information of the luminaire in the shooting scene, without the need for manual assignment, thereby improving the efficiency of DMX address assignment; the DMX address is sent to the second NFC module of the luminaire in the shooting scene by the first NFC module of the control terminal, and the DMX address received by the second NFC module of the luminaire can be read after the control module of the luminaire is powered on, thereby configuring the DMX address of the luminaire, reducing manual intervention and improving the efficiency of DMX address configuration.

In some embodiments, operation 320 includes:

comparing the DMX address with the initial DMX address recorded in the control module; and

if the comparison result is different, the initial DMX address is updated to the DMX address received by the second NFC module.

Specifically, the initial DMX address refers to the DMX address previously configured for the luminaire by the control module of the luminaire control device.

After receiving the DMX address, the luminaire control device first stores the DMX address in the second NFC module of the luminaire control device. When the control module of the luminaire control device is started, that is, after power is turned on, the DMX address will be read from the second NFC module and compared with the initial DMX address. If they are the same, it indicates that the current DMX address has not been updated. If they are different, it indicates that the current DMX address has been updated, and the initial DMX address is updated to the DMX address in the second NFC module.

The DMX address configuration method for luminaire provided in the embodiments of the present application updates the initial DMX address recorded in the control module of the luminaire control device based on the DMX address, thereby ensuring that the configured DMX address is the latest address and improving configuration efficiency.

In some embodiments, after operation 120, the method further includes:

comparing the configured DMX address of the luminaire with the DMX address associated with the luminaire recorded in the application of the control terminal;

when the comparison result is different, address configuration abnormality information is generated and displayed on the control interface of the luminaire.

Specifically, after configuring the DMX address of a luminaire to which the luminaire control device is communicating, to confirm whether the configuration is successful, the configured DMX address can be compared with the DMX address associated with the luminaire ID of the luminaire recorded in the application of the control terminal. If the comparison result is the same, it indicates that the configuration is successful; if the comparison result is different, it indicates that the configuration failed. Address configuration abnormality information is generated based on the comparison result and displayed on the display interface of the luminaire control device. The address configuration abnormality information can include the configured DMX address and the DMX address recorded in the application of the control terminal.

After the DMX address of the luminaire is configured, the display interface of the luminaire control device will automatically jump to the configuration interface, which can remind the staff to check and compare the configured DMX address with the DMX address associated with the luminaire identifier of the luminaire recorded in the application of the control terminal.

The DMX address configuration method for luminaire provided in the embodiments of the present application further detects whether the configuration is correct after the DMX address of the luminaire is configured, thereby improving the accuracy of the configuration and providing a prompt reminder to relevant personnel to check the cause of the failure when the configuration fails.

It should be noted here that the DMX address configuration method for luminaire whose execution subject is a luminaire provided in the embodiments of the present application can implement all the operations implemented in the above- mentioned DMX address configuration method for luminaire whose execution subject is a control terminal, and can achieve the same technical effect. The parts and beneficial effects of this embodiment that are the same as the above-mentioned embodiments will not be described in detail here.

The followings describe an address configuration device provided in embodiments of the present application. The address configuration device described below and the DMX address configuration method for luminaire described above can be referenced to each other.

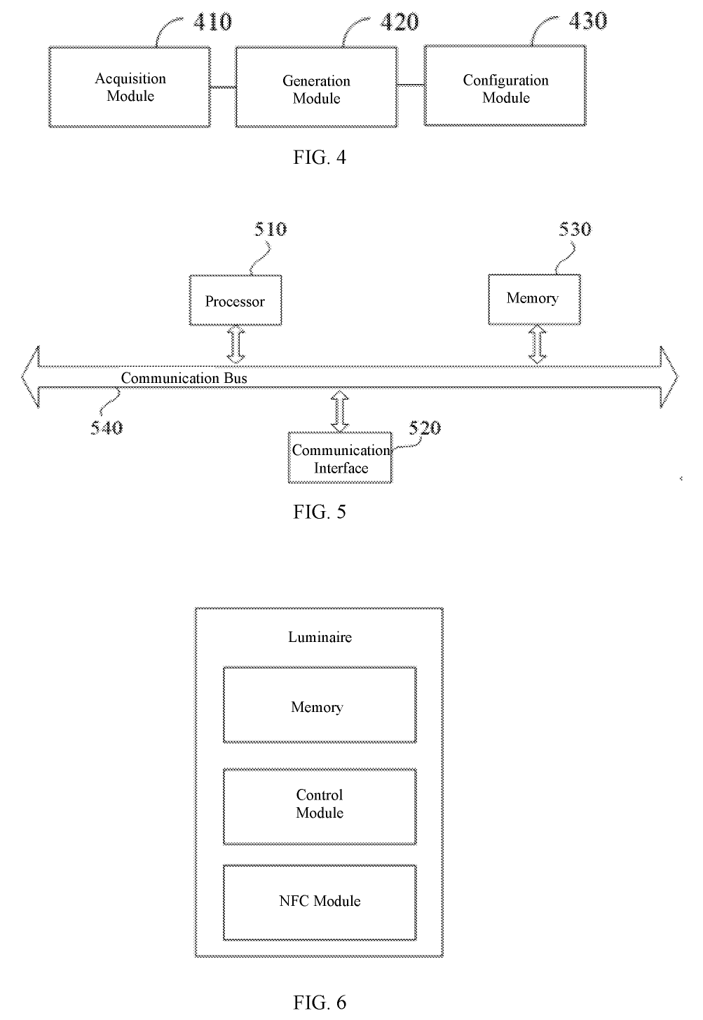

FIG. 4 is a schematic diagram of the structure of an address configuration device according to an embodiment of the present application. As shown in FIG. 4, the device is applied to a control terminal and includes an acquisition module 410, a generation module 420 and a configuration module 430.

The acquisition module 410 is configured to acquire luminaire position information of one or more luminaires in a shooting scene, wherein the luminaire includes a second NFC module and a control module, and the control module is communicatively connected with the second NFC module;

The generation module 420 is configured to generate a DMX address of each of the one or more luminaires based on the luminaire position information;

The configuration module 430 is configured to write the DMX address of each of the one or more luminaires into the second NFC module of the one or more luminaires by using the first NFC module, so that the control module of each luminaire can read the DMX address received by the second NFC module of the luminaire after powering on.

Specifically, according to an embodiment of the present application, any multiple modules among the acquisition module 410, the generation module 420 and the configuration module 430 can be combined into one module for implementation, or any one of the modules can be split into multiple modules.

Alternatively, at least part of the functionality of one or more of these modules may be combined with at least part of the functionality of other modules and implemented in one module.

According to an embodiment of the present application, at least one of the acquisition module 410, the generation module 420 and the configuration module 430 can be at least partially implemented as a hardware circuit, such as a field programmable gate array (FPGA), a programmable logic array (PLA), a system on a chip, a system on a substrate, a system on a package, an application-specific integrated circuit (ASIC), or can be implemented by hardware or firmware such as any other reasonable way of integrating or packaging the circuit, or implemented in any one of the three implementation methods of software, hardware and firmware, or in an appropriate combination of any of them.

Alternatively, at least one of the acquisition module 410, the generation module 420, and the configuration module 430 may be at least partially implemented as a computer program module, and when the computer program module is executed, the corresponding function can be performed.

It should be noted here that the DMX address configuration device for luminaire provided in the embodiments of the present application can implement all the method operations implemented in the above-mentioned DMX address configuration method for luminaire, and can achieve the same technical effects. The parts and beneficial effects of this embodiment that are the same as those in the method embodiment will not be described in detail here.

In another aspect, an embodiment of the present application also provides a luminaire control system, including a control terminal and a luminaire. The control terminal is used to execute the above-mentioned DMX address configuration method for luminaire applied to the control terminal; and/or, the luminaire is used to execute the above-mentioned DMX address configuration method for luminaire applied to the luminaire.

In another aspect, an embodiment of the present application further provides an application program, which, when executed by a processor, implements the above-mentioned DMX address configuration method for luminaire applied to the control terminal.

FIG. 5 is a schematic structural diagram of an electronic device according to an embodiment of the present application. As shown in FIG. 5, the electronic device may include: a processor 510, a communication interface 520, a memory 530, and a communication bus 540. The processor 510, the communication interface 520, and the memory 530 communicate with each other via the communication bus 540. The processor 510 may call a computer program in the memory 530 to execute the above method, for example, including:

acquiring luminaire position information of one or more luminaires in a shooting scene, wherein the luminaire includes a second NFC module and a control module, and the control module is communicatively connected with the second NFC module;

generating a DMX address of each of the one or more luminaires based on the luminaire position information; and

writing, by the first NFC module, the DMX address of each of the one or more luminaires into the second NFC module of the corresponding one of the one or more luminaires, so that the control module of each luminaire can read the DMX address received by the second NFC module of the luminaire after powering on.

In addition, the logical instructions in the above-mentioned memory can be implemented in the form of software function modules and can be stored in a computer-readable storage medium when sold or used as an independent product. Based on this understanding, the technical solution of the present application, or the part that contributes to the existing technology, or the part of the technical solution, can be embodied in the form of a software product. The computer software product is stored in a storage medium and includes several instructions for enabling a computer device (which can be a personal computer, server, or network device, etc.) to execute all or part of the operations of the various embodiments of the present application. The aforementioned storage medium includes: Universal Serial Bus (USB) Flash Drive, Mobile Hard Disk Drive (Mobile HDD), Read-Only Memory (ROM), Random Access Memory (RAM), disk, disc or optical disk, and other media that can store programmable codes.

FIG. 6 is a schematic structural diagram of a luminaire according to an embodiment of the present application. As shown in FIG. 6, the luminaire provided in an embodiment of the present application includes a memory, a control module and an NFC module. The memory stores a computer program, and the control module is configured to execute the above-mentioned DMX address configuration method for luminaire applied to the luminaire by using the computer program.

In another aspect, an embodiment of the present application also provides a computer program product, which includes a computer program. The computer program can be stored on a non-transitory computer-readable storage medium. When the computer program is executed by a processor, the computer can execute the methods provided in the above embodiments.

In another aspect, an embodiment of the present application further provides a processor-readable storage medium, which stores a computer program used to enable the processor to execute the methods provided in the above embodiments.

The processor-readable storage medium can be any available medium or data storage device that can be accessed by the processor, including but not limited to magnetic storage (such as floppy disk, hard disk, magnetic tape, magneto-optical disk (MO), etc.), optical storage (such as Compact Disk (CD), Digital Versatile Disk (DVD), Blu-Ray Disk (BD), Holographic Versatile Disk (HVD), etc.), and semiconductor storage (such as ROM, Erasable Programmable Read-Only Memory (EPROM), Electrically Erasable Programmable Read-Only Memory (EEPROM), NAND Flash memory (NAND FLASH), Solid-State Drive (SSD)), etc.

Embodiments described above are merely illustrative. Modules described as separate components may or may not be physically separate, and components shown as modules may or may not be physical modules, i.e., they may be located in one place or distributed across multiple network modules. Some or all of the modules may be selected based on actual needs to achieve the objectives of the present embodiment. Persons of ordinary skill in the art will be able to understand and implement the present invention without inventive effort.

Based on the above description of the embodiments, those skilled in the art will clearly understand that each embodiment can be implemented using software with a necessary general-purpose hardware platform, or of course, hardware. Based on this understanding, the essence of the above technical solution, or the portion that contributes to the prior art, can be embodied in the form of a software product. This computer software product can be stored in a computer-readable storage medium, such as ROM/RAM, a magnetic disk, or an optical disk, and includes a number of instructions for causing a computer device (such as a personal computer, server, or network device) to execute the methods of each embodiment or certain portions of the embodiments.

The above is a detailed introduction to the embodiments of the present application. Specific examples are used in the present application to illustrate the principles and implementations of the present application. The description of the above embodiments is only used to help understand the method and core idea of the present application. In addition, for technical personnel in this field, based on the ideas of the present application, there will be changes in the specific implementations and application scope. In summary, the content of this specification should not be understood as a limitation on the present application.

What is claimed is:

1. A Digital Multiplex (DMX) address configuration method for luminaire, applied to a control terminal comprising a first Near Field Communication (NFC) module, the method comprising:
acquiring luminaire position information of one or more luminaires in a shooting scene, wherein each of the one or more luminaires comprises a second NFC module and a control module communicatively connected with the second NFC module;
generating a DMX address of each of the one or more luminaires based on the luminaire position information; and
writing, by the first NFC module, the DMX address of each of the one or more luminaires into the second NFC module of a corresponding one of the one or more luminaires, so that upon being powered on, the control module of each of the one or more luminaires reads the DMX address received by the second NFC module of the luminaire.

2. The DMX address configuration method for luminaire according to claim 1, wherein the acquiring of the luminaire position information of the one or more luminaires in the shooting scene comprises:
acquiring one or both of a scene image or a scene video of the shooting scene; and
obtaining the luminaire position information by identifying the one or both of the scene image and the scene video.

3. The DMX address configuration method for luminaire according to claim 2, further comprising:
inputting an environmental image of the shooting scene into an address configuration model; and
in a condition that any of the one or more luminaires is included in the environmental image, obtaining the DMX address generated by the address configuration model based on the luminaire position information in the environmental image;
in a condition that none of the one or more luminaires is included in the environmental image, obtaining the luminaire position information output by the address configuration model and the DMX address generated by the address configuration model based on the luminaire position information.

4. The DMX address configuration method for luminaire according to claim 2, wherein after acquiring the scene image of the shooting scene, the obtaining of the luminaire position information by identifying the scene image comprises:
analyzing the scene image to identify each of the one or more luminaires in the scene image;
acquiring relative position relations and quantity information of the one or more luminaires in the scene image; and
determining the luminaire position information based on the relative position relations and the quantity information.

5. The DMX address configuration method for luminaire according to claim 1, wherein the acquiring of the luminaire position information of the one or more luminaires in the shooting scene comprises:
matching first scene information of the shooting scene with second scene information of a past shooting scene; and
taking luminaire position information of one or more luminaires in the past shooting scene corresponding to the second scene information that matches with the first scene information as the luminaire position information of the one or more luminaires in the shooting scene.

6. The DMX address configuration method for luminaire according to claim 1, wherein the luminaire position information comprises a relative position relation of each of the one or more luminaires and quantity information of the one or more luminaires, and wherein the generating of the DMX address of each of the one or more luminaires based on the luminaire position information comprises:
determining a quantity of the DMX addresses based on the quantity information of the one or more luminaires; and
generating the DMX address of each of the one or more luminaires based on the quantity of the DMX addresses and the relative position relations.

7. The DMX address configuration method for luminaire according to claim 2, wherein the writing of the DMX address of each of the one or more luminaires into the second NFC module of the corresponding one of the one or more luminaires comprises:
detecting whether the first NFC module is connected with the second NFC module of any of the one or more luminaires in the shooting scene; and
in a condition that the first NFC module is connected with the second NFC module of one of the one or more luminaires in the shooting scene, transmitting the DMX address associated with the luminaire to the second NFC module of the luminaire.

8. The DMX address configuration method for luminaire according to claim 6, further comprising:
turning on the first NFC module;
in a condition that the first NFC module is connected with the second NFC module, generating a Bluetooth connection signal;
transmitting the Bluetooth connection signal to the control module communicatively connected with the second NFC module, so that the control module enables a Bluetooth connection function based on the Bluetooth connection signal; and
identifying the control module and establishing a Bluetooth connection with the control module to transmit data through the Bluetooth connection.

9. A Digital Multiplex (DMX) address configuration method for luminaire, applied to a luminaire comprising a second Near Field Communication (NFC) module and a control module, the method comprising:
receiving, by the second NFC module, a DMX address of the luminaire in the shooting scene transmitted from the control terminal; and
upon being powered on, reading the DMX address, and performing DMX address configuration on the luminaire based on the DMX address;
wherein the DMX address is generated based on position information of the luminaire in the shooting scene.

10. The DMX address configuration method for luminaire according to claim 9, wherein the performing of the DMX address configuration on the luminaire based on the DMX address comprises:
comparing the DMX address with an initial DMX address recorded in the control module; and
if the DMX address is different from the initial DMX address, updating the initial DMX address to the DMX address received by the second NFC module.

11. The DMX address configuration method for luminaire according to claim 9, wherein after performing the DMX address configuration on the luminaire based on the DMX address, the method further comprises:
comparing the configured DMX address of the luminaire with an DMX address associated with the luminaire recorded in an application program of the control terminal;
if the configured DMX address is different from the DMX address associated with the luminaire recorded in the application program of the control terminal, generating address configuration abnormality information and displaying the address configuration abnormality information on a control interface of the luminaire.

12. A luminaire control system, comprising:
a control terminal; and
a luminaire,
wherein the control terminal is configured to perform the DMX address configuration method for luminaire according to claim 1.

13. A luminaire control system, comprising:
a control terminal; and
a luminaire,
wherein the luminaire is configured to perform the DMX address configuration method for luminaire according to claim 9.

14. An application program, which, when executed by a processor, causes the processor to implement the DMX address configuration method for luminaire according to claim 1.

15. An electronic device, comprising:
a memory having stored thereon a computer program; and
a processor,
wherein the computer program, when executed by the processor, causes the processor to implement the DMX address configuration method for luminaire according to claim 1.

16. A luminaire, comprising:
a memory having stored thereon a computer program; and
a control module,
wherein the computer program, when executed by the control module, causes the control module to execute the DMX address configuration method for luminaire according to claim 9.
